(19) United States
(12) Patent Application Publication
(10) Pub. No.: US 2009/0109202 A1
(43) Pub. Date: Apr. 30, 2009

(54) LIQUID CRYSTAL DISPLAY DEVICE AND DRIVING METHOD FOR THE SAME

(75) Inventor: Yoshiro KITAGAWA, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD., Kawasaki-shi (JP)

(21) Appl. No.: 12/259,896

(22) Filed: Oct. 28, 2008

(30) Foreign Application Priority Data
Oct. 29, 2007 (JP) 2007-280673

(51) Int. Cl. G06F 3/038

(52) U.S. Cl. 345/206

(57) ABSTRACT

A liquid crystal display device according to an exemplary aspect of the invention includes a thin film transistor (TFT) substrate having a substrate and a display pixel arranged in a matrix form on the substrate, a counter substrate opposed to the TFT substrate, the pixel electrode and the first surface common electrode are arranged so that an electric field along a principal plane of said TFT substrate can be applied to the liquid crystal, a second surface common electrode is formed on the counter substrate, a same common electric potential is inputted into the second surface common electrode as well as into the first surface common electrode, the second surface common electrode is opposed to the first surface common electrode, and the second surface common electrode is arranged so that an electric field along a principal plane of the counter substrate can be applied to the liquid crystal.

### INCORPORATION BY REFERENCE

This application is based upon and claims the benefit of priority from Japanese Patent Application No. 2007-280673, filed on Oct. 29, 2007, the disclosure of which is incorporated herein in its entirety by reference.

### BACKGROUND OF THE INVENTION

1. Technical Field

The present invention relates to a liquid crystal display (LCD) device and a driving method for the same and in particular, relates to an IPS (in-plane-switching) mode LCD device and the driving method for the same.

2. Background Art

In recent years, a liquid crystal display (LCD) device with a wide viewing angle has been developed. An IPS (in-plane-switching) mode is one of the methods for realizing a wide viewing angle of the LCD device. In the IPS mode LCD device, comb-shaped electrodes are formed only on a surface of one substrate of a pair of substrates which an LCD panel has, and a liquid crystal is driven by a transverse electric field parallel to the both substrates. In this IPS mode, when an electric field is applied to a liquid crystal, a liquid crystal molecule rotates in parallel with a substrate. Therefore, even when seen from every viewing angle, a refractive index change in the liquid crystal molecule hardly occurs and a desired image is obtained with a wide viewing angle. For this reason, this IPS mode is noted from a view of a super-wide viewing angle recently.

FIG. 16 is a plan view of a thin film transistor (TFT) substrate 1001 provided in a related IPS mode LCD device 1000 (FIG. 17), and FIG. 17 is a cross sectional view of the LCD device 1000. FIG. 17 is a cross sectional view of a part corresponding to the line XVII-XVII in FIG. 16.

As shown in FIG. 17, the LCD device 1000 is provided with the TFT substrate 1001 and a color filter substrate 1002 opposing the TFT substrate 1001. The color filter substrate 1002 is stuck on the TFT substrate 1001, and a liquid crystal layer 1003 is inserted therebetween.

The TFT substrate 1001 includes a flat glass substrate 1004 with a scanning line 1007 and a common electrode wiring 1006 formed thereon, a first insulating layer 1005 formed on the glass substrate 1004 so as to cover the scanning lines 1007 and the common electrode wiring 1006, a data line (signal line) 1008, a storage capacitance formation part 1009B (mentioned later) of a pixel electrode 1009 and a thin film transistor (TFT) 1014 which are formed on the first insulating layer 1005, a second insulating layer 1010 formed on the first insulating layer 1005 so as to cover the data lines 1008, the storage capacitance formation part 1009B and the thin film transistor 1014, a surface common electrode 1011 and a pixel electrode comb-tooth 1009A (mentioned later) of the pixel electrode 1009 which are formed on the second insulating film 1010, and an alignment film 1012 formed on the second insulating film 1010 to cover the surface common electrode 1011 and the pixel electrode comb-tooth 1009A.

The common electrode wiring 1006 and the scanning line 1007 extend in a row direction (an X direction of FIG. 16), respectively, and several these lines are formed with a predetermined interval. The data line 1008 extends in a column direction (a Y direction of FIG. 16) which intersects perpendicularly to the row direction, and several these lines are formed with a predetermined interval. The common electrode wiring 1006, the scanning line 1007 and the data line 1008 are composed of metallic films, for example.

The pixel electrode 1009 is composed of comb-shaped pixel electrode comb-teeth 1009A and a storage capacitance formation part 1009B. As shown in FIG. 16, the pixel electrode comb-tooth 1009A is located in a display area 1013 which is inserted between the common electrode wiring 1006 and the scanning line 1007, and is inserted between the adjacent data lines 1008. The pixel electrode comb-teeth 1009A are electrically connectable with the data line 1008 via the TFT 1014, and a pixel potential will be applied thereto from the data line 1008.

The storage capacitance formation part 1009B is located over the common electrode wiring 1006 and under a latticed part 1011A (mentioned later) of the surface common electrode 1011, and extends in a row direction. The storage capacitance formation part 1009B forms a capacitance with the surface common electrodes 1011.

The surface common electrode 1011 includes the latticed part 1011A and the common electrode comb-teeth 1011B. The latticed part 1011A has an approximately latticed shape pattern, which is arranged to cover the data line 1008 and the common electrode wiring 1006 and the display area 1013 is surrounded therewith. And the latticed part 1011A is electrically connected with the common electrode wiring 1006 via a contact hole which is not illustrated. The common electrode comb-tooth 1011B having a shape of a comb-tooth is formed every display area 1013, and is projected into the display area 1013 out of a part in the latticed part 1011A. Since the pixel electrode comb-tooth 1009A and the common electrode comb-tooth 1011B project into the display area 1013, an electric field along a principal plane of the TFT substrate 1001 can be applied to a liquid crystal molecule of the liquid crystal layer 1003.

On the other hand, the color filter substrate 1002 includes a flat glass substrate 1020, a black matrix layer 1021 formed on the glass substrate 1020, a color layer 1022 formed on the glass substrate 1020 so as to cover the black matrix layer 1021, and an alignment film 1024 formed on the color layer 1022. The black matrix layer 1021 is formed in a plane shape of an approximately latticed shape so as to oppose and cover the data line 1008, the scanning line 1007 and the common electrode wiring 1006 on the TFT substrate 1001. The black matrix layer 1021 has a light-shielding function.

The surface layer of the color filter substrate 1002 is made of conductive material, such as a color layer and a black matrix layer, and is not grounded. Therefore electrical charge is accumulated by an electric field from the TFT substrate, or movement of ion therein. By the accumulation of this charge, an electric field in the vertical direction is generated and it disturbs an electric field applied in parallel to the TFT substrate 1001 and the color filter substrate 1002. Therefore the failures, such as a spot, stain and an afterimage, etc. may arise on an image, or a screen burn-in may be generated.

One of the related arts for solving the accumulation of the charge in the surface layer of the color filter substrate in an IPS mode LCD device is disclosed in Japanese Patent Application Laid-Open No. 2000-147482.

FIG. 18 is a cross sectional view of a LCD device 2000 described in Japanese Patent Application Laid-Open No. 2000-147482, and FIG. 19 is a plan view showing a second surface common electrode 1023 provided in a color filter substrate of the LCD device 2000. A TFT substrate provided in the LCD device 2000 is the same as the TFT substrate 1001 of the LCD device 1000 shown in FIG. 16 and FIG. 17.

As shown in FIG. 18 and FIG. 19, the second surface common electrode 1023 is formed in the color filter substrate 1002 of the LCD device 2000 so as to cover a black matrix layer 1021. The LCD device 2000 is the same as the LCD device 1000 shown in FIG. 16 and FIG. 17, except for the second surface common electrode 1023.

In the LCD device 2000, generation of the failures on an image or a screen burn-in can be suppressed, because accumulation of the charge in the black matrix layer 1021 is suppressed with the surface common electrode 1023.

Japanese Patent Application Laid-Open No. 2006-031022 discloses another type of an LCD device which has a counter electrode in a TFT substrate and a transparent auxiliary electrode in a color filter substrate, respectively, and the same voltage is applied to the counter electrode and the transparent auxiliary electrode.

### SUMMARY

An exemplary object of the present invention is to provide an LCD device in which generation of screen burn-in and spots, stains and an afterimage, etc. by charge accumulation in the counter substrate can be suppressed, and a driving voltage is decreased.

A liquid crystal display device according to an exemplary aspect of the invention includes a thin film transistor (TFT) substrate having a substrate and a display pixel arranged in a matrix form on the substrate, with the display pixel including a plurality of scanning lines, a plurality of signal lines, a plurality of common electrode wirings, a plurality of pixel electrodes, a plurality of thin film transistors and a first surface common electrode connected with the common electrode wiring, a counter substrate opposed to the TFT substrate and being stuck therewith and a liquid crystal enclosed between the TFT substrate and the counter substrate, the pixel electrode and the first surface common electrode are arranged so that an electric field along a principal plane of said TFT substrate can be applied to the liquid crystal, a second surface common electrode is formed on the counter substrate, a same common electric potential is inputted into the second surface common electrode as well as into the first surface common electrode, the second surface common electrode is opposed to the first surface common electrode, the counter substrate further has a light-shielding layer with a light-shielding function, the second surface common electrode is formed covering the light-shielding layer, and the second surface common electrode is arranged so that an electric field along a principal plane of the counter substrate can be applied to the liquid crystal.

### BRIEF DESCRIPTION OF THE DRAWINGS

Exemplary features and advantages of the present invention will become apparent from the following detailed description when taken with the accompanying drawings in which:

FIG. 1 is a plan view of a TFT substrate provided in an LCD device according to a first exemplary embodiment;

FIG. 2 is a cross sectional view taken along the line II-II in FIG. 1;

FIG. 3 is a cross sectional view taken along the line III-III in FIG. 1;

FIG. 4 is a plan view of a first surface common electrode provided in the TFT substrate of the LCD device according to the first exemplary embodiment;

FIG. 5 is a plan view of a second surface common electrode provided in a color filter substrate of the LCD device according to the first exemplary embodiment;

FIG. 6 is a cross sectional view showing a structure of a conduction part in a modification 1 of the first exemplary embodiment;

FIG. 7 is a cross sectional view showing a structure of a conduction part in a modification 2 of the first exemplary embodiment;

FIG. 8 is a cross sectional view showing a structure of a conduction part in a modification 3 of the first exemplary embodiment;

FIG. 9 is a cross sectional view showing another structure of a conduction part in a modification 3 of the first exemplary embodiment;

FIG. 10 is a plan view of a TFT substrate provided in an LCD device according to a second exemplary embodiment;

FIG. 11 is a plan view of a first surface common electrode provided in the TFT substrate of the LCD device according to the second exemplary embodiment;

FIG. 12 is a plan view of a second surface common electrode provided in a color filter substrate of the LCD device according to the second exemplary embodiment;

FIG. 13 is a cross-sectional view showing a structure of a peripheral edge part of a TFT substrate and a color filter substrate of a LCD device according to a third exemplary embodiment;

FIG. 14 is a plan view of the LCD device according to the third exemplary embodiment;

FIG. 15 is a cross sectional view of the LCD device according to the third exemplary embodiment;

FIG. 16 is a plan view of a TFT substrate provided in a related IPS mode LCD device;

FIG. 17 is a cross sectional view taken along the line XVII-XVII in FIG. 16;

FIG. 18 is a cross-sectional view of another related LCD device; and

FIG. 19 is a plan view showing a second surface common electrode provided in a TFT substrate of another related LCD device.

### EXEMPLARY EMBODIMENT

Exemplary embodiments of the present invention will now be described in detail in accordance with the accompanying drawings.

### A First Exemplary Embodiment

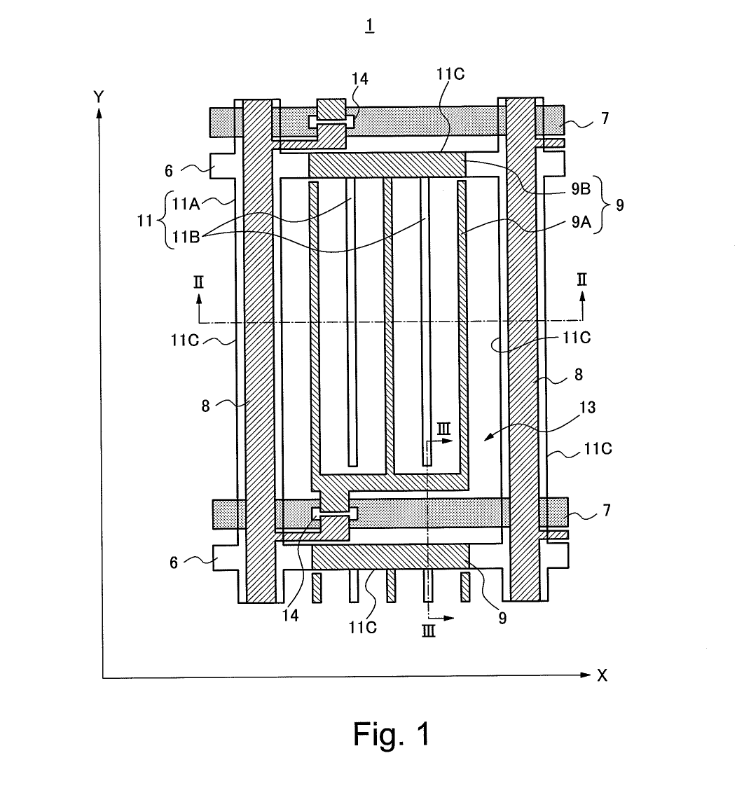

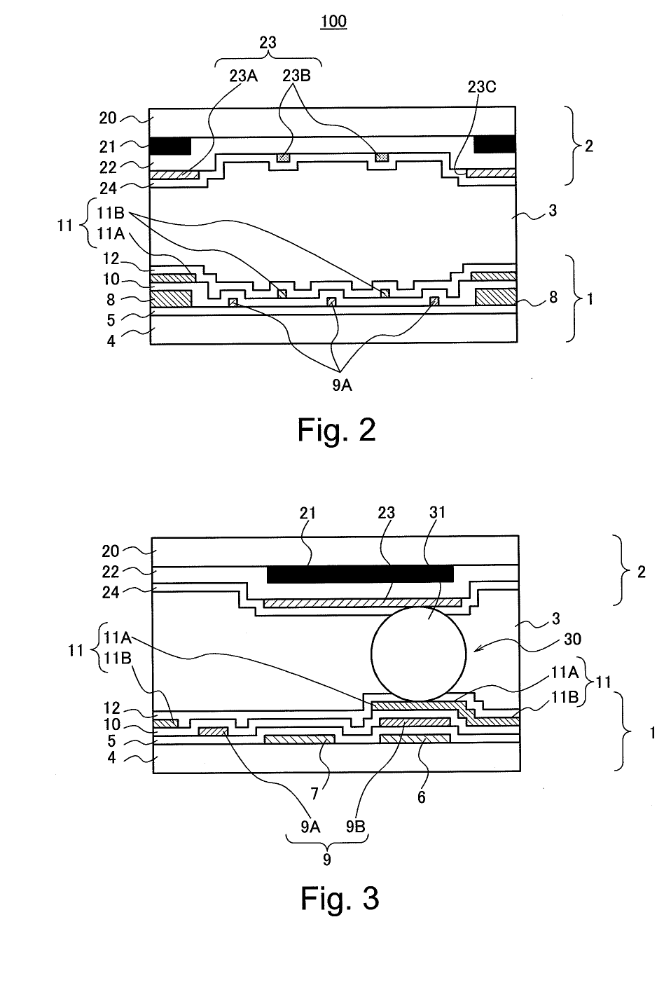

FIG. 1 is a plan view of a TFT substrate 1 for an LCD device 100 (FIG. 2) according to a first exemplary embodiment, and FIG. 2 and FIG. 3 are cross sectional views of the LCD device 100 according to the first exemplary embodiment. Here, FIG. 2 is the cross sectional view of a part corresponding to the line II-II in FIG. 1, and FIG. 3 is the cross sectional view of a part corresponding to the line III-III in FIG. 1.

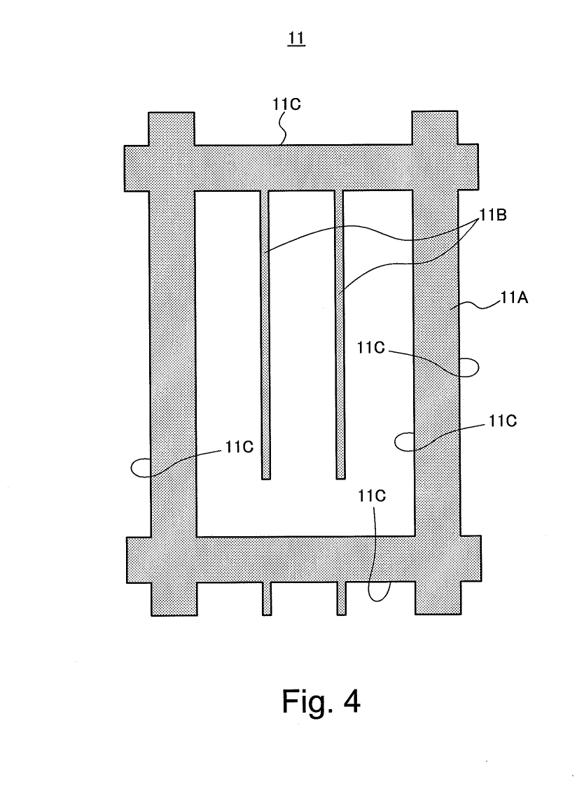

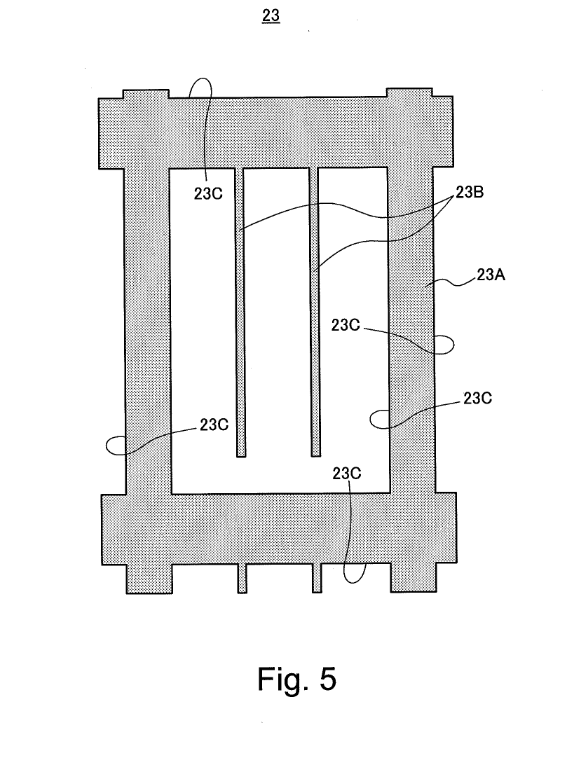

FIG. 4 is a plan view of a first surface common electrode 11 provided on the TFT substrate 1, and FIG. 5 is a plan view of a second surface common electrode 23 provided on the color filter substrate 2 of the LCD device 100.

The LCD device 100 is an LCD device called a transverse electric field mode or an IPS (in-plane-switching) mode. As shown in FIG. 2 and FIG. 3, the LCD device 100 includes the TFT substrate 1 and the color filter substrate 2 opposing the TFT substrate 1. The color filter substrate 2 is stuck on the TFT substrate 1, and a liquid crystal layer 3 is interposed therebetween.

The TFT substrate 1 includes a flat glass substrate 4 as an example of a preferable substrate, a common electrode wiring 6 and a scanning line 7 formed on the glass substrate 4, a first insulating film 5 formed on the glass substrate 4 so as to cover the common electrode wiring 6 and the scanning line 7, a data line (signal line) 8, a pixel electrode 9, and a switching element 14 such as a thin-film transistor (TFT) which are formed on the first insulating film 5. The TFT substrate 1 further includes a second insulating film 10 formed on the first insulating film 5 so as to cover these data line 8, pixel electrode 9, and the switching element or TFT 14, a first surface common electrode 11 formed on the second insulating film 10 and an alignment film 12 formed on the second insulating film 10 so as to cover the first surface common electrode 11 and a pixel electrode comb-tooth 9A.

On the glass substrate 4, as shown in FIG. 1, more specifically, several common electrode wirings 6 extending respectively in a row direction (an X direction in FIG. 1), are formed with a predetermined interval. A plurality of scanning lines 7 are formed with a predetermined interval along the respective common electrode wirings 6. On the first insulating film 5, several data lines 8 extending respectively in a column direction (a Y direction in FIG. 1) which intersect perpendicularly to the row direction, are formed with a predetermined interval. Here, the common electrode wiring 6, the scanning line 7 and the data line 8 are composed of metallic films, for example.

A display pixel demarcated by the common electrode wiring 6, the scanning line 7 and the data line 8 constitutes the LCD device 100, and a plurality of display pixels are arranged in a matrix form in a row direction and a column direction. The respective display pixels have a pixel electrode 9, a first surface common electrode 11, a TFT 14, and a display area 13.

The pixel electrode 9 is composed of a comb-shaped pixel electrode comb-tooth (comb-tooth-shaped portion) 9A and a storage capacitance formation part 9B. As shown in FIG. 1, the pixel electrode comb-tooth 9A is located in an area surrounded by the pixel electrode wiring 6, the scanning line 7, and the adjacent data lines 8, i.e., in the display area 13. In FIG. 1, although the case where the pixel electrode comb-tooth 9A has three comb-tooth-shaped portions is shown, the number of the comb-tooth-shaped portion is not restricted to this, but can be changed suitably. The pixel electrode comb-tooth 9A is electrically connectable with the data line 8 via the TFT 14. That is, when the TFT 14 is set to ON, the pixel electrode comb-tooth 9A will electrically be connected with the data line 8 via the TFT 14, and pixel potential will be applied to the pixel electrode comb-tooth 9A via the TFT 14 from the data line 8.

The storage capacitance formation part 9B is located over the common electrode wiring 6 and under a latticed part 11A (mentioned later) of the first surface common electrode 11, and extends in a row direction. This storage capacitance formation part 9B forms a capacitance with the first surface common electrodes 11.

As shown in FIG. 1 and FIG. 2, an opening 11C is formed in the first surface common electrode 11 in a position corresponding to each display area 13. That is, the opening 11C is formed in a row direction and a column direction in a matrix form. Here, the first surface common electrode 11 includes a latticed part 11A and a common electrode comb-tooth 11B of which the opening 11C is composed. This latticed part 11A is a pattern of an approximately latticed shape which covers the data line 8 and the common electrode wiring 6, and surrounds each display area 13. And the latticed part 11A supplies a common electric potential to the common electrode comb-tooth 11B in each display pixel. The latticed part 11A also further has a function to prevent electric field leakage from the data line 8 to the liquid crystal layer 3. The latticed part 11A of the first surface common electrode 11 is electrically connected with the common electrode wiring 6 via a contact hole which is not illustrated.

The common electrode comb-tooth 11B is a portion projected over a display area 13 in a shape of a comb-tooth from a part in the latticed part 1A which covers the common electrode wiring 6, and is formed in every display area 13. Although the case where the first surface common electrode 11 is provided with two common electrode comb-teeth 11B in each display area 13 is shown in FIG. 1, the number of the common electrode comb-tooth 11B is not limited to this and is changed suitably.

The pixel electrode comb-tooth 9A and the common electrode comb-tooth 11B are arranged so that they may project into the display area 13, and an electric field is applied along a principal surface of the TFT substrate 1 to a liquid crystal material which constitutes the liquid crystal layer 3. Thus, a driving voltage can be reduced.

On the other hand, as shown in FIG. 2, the color filter substrate 2 includes a flat glass substrate 20, a black matrix layer 21 formed on the glass substrate 20, a color layer 22 formed on the glass substrate 20 so as to cover the black matrix layer 21, a second surface common electrode 23 formed on the color layer 22, and an alignment film 24 formed on the color layer 22 so as to cover the second surface common electrode 23.

The black matrix layer 21 with a light-shielding function is arranged so as to be opposed to the data line 8, the scanning line 7 and the common electrode wiring 6 of the TFT substrate 1, and it is formed in a plane shape of an approximately latticed planar shape so as to cover them. Other light shielding layer with a light-shielding function may be formed instead of the black matrix layer 21.

The color layer 22 includes paint with a color corresponding to a display color (for example, any one color of red, blue, and green) which is set up every display area 13 in order to perform color display. An overcoat (not shown) which covers the color layer 22 may be further formed on the color layer 22.

The second surface common electrode 23 is an almost same shape as the first surface common electrode 11. As shown in FIG. 2, FIG. 3 and FIG. 5, an opening 23C is formed in the second surface common electrode 23 in a position corresponding to each display area 13. That is, the second surface common electrode 23 has an opening 23C which is formed in a row direction and a column direction in a matrix form. And the second surface common electrode 23 is composed of a latticed part 23A and a surface common electrode comb-tooth 23B. The latticed part 23A has a pattern shape of an approximately latticed shape which covers the black matrix layer 21 and is opposed to the latticed part 11A which constitutes the first surface common electrode 11. The surface common electrode comb-tooth 23B has a comb-tooth shape, and is opposed to the surface common electrode comb-tooth 11B of the first surface common electrode 11. The latticed part 23A of the second surface common electrode 23 has the part extending to a row direction whose width is wider than that of the latticed part 11A of the first surface common electrode 11 by the width of the part which covers the scanning line 7. Here, the second surface common electrode 23, the first surface common electrode 11 and the pixel electrode 9 may be opaque films of metal and may be transparent films of indium tin oxide (ITO) or the like.

As shown in FIG. 3, the latticed part 23A of the second surface common electrode 23 and the latticed part 11A of the first surface common electrode 11 are electrically connected, for example via a conductive spacer 31 in a conduction part 30 located in an outside of the display area 13. Preferably, the conductive spacer 31 is spherical or columnar, for example, but it may be other shape. The conductive spacer 31 is formed by coating a metal (gold etc.) on a resin, for example, and is arranged by means of an ink jet method or a printing method in a fixed position on the alignment film 24 or the alignment film 12. Here, the conductive spacer 31 has another function to keep equal in the thickness of the liquid crystal layer 3 between the TFT substrate 1 and the color filter substrate 2. As long as the conduction between the second surface common electrode 23 and the first surface common electrode 11 is obtained, a position of the conduction part 30 will not be restricted to the position shown in FIG. 3.

In this exemplary embodiment, the conductive spacer 31 is arranged between the TFT substrate 1 and the color filter substrate 2 by pressurization which is applied to at the time when the TFT substrate 1 and the color filter substrate 2 are made oppose and stuck together. Therefore, as shown in FIG. 3, the conductive spacer 31 breaks through the alignment films 12 and 24, and can contact with the second surface common electrode 23 and the first surface common electrode 11, respectively. Accordingly, conduction between the second surface common electrode 23 and the first surface common electrode 11 is fully obtained. The conduction parts 30 may be arranged near every display pixel. And the conduction part 30 may be arranged only near the predetermined display pixel, for example, one of conduction parts 30 may be arranged per predetermined number of display pixel. A conductive pillar (mentioned later) or a silver (Ag) paste other than the conductive spacers 31 may constitute the conduction part 30, for example. It is also possible to electrically connect the second surface common electrode 23 to the first surface common electrode 11 mutually in the inside of the display area 13.

In general, in order to supply common electric potential to the color filter substrate 2, a conductive spacer can be mixed in a sealing agent by which the color filter substrate 2 and the TFT substrate 1 are connected in their peripheral edge parts, or a process of spotting a silver (Ag) paste may be used. However, according to this exemplary embodiment, by means of providing the conductive spacer 31, these processes can be omitted.

Next, operation of the LCD device 100 according to this exemplary embodiment is described.

As shown in FIG. 3, since the second surface common electrode 23 is electrically connected to the first surface common electrode 11, it is electrically connected to the common electrode wiring 6 via the first surface common electrode 11. Therefore the common potential inputted into the common electrode wiring 6 is supplied to the first surface common electrode 11 and the second surface common electrode 23. An electric field along a principal plane of the TFT substrate 1 and the color filter substrate 2 is suitably applied to the liquid crystal layer 3 via common electrode comb-teeth 11B and 23B provided in the first surface common electrode 11 and the second surface common electrode 23, respectively.

According to the first exemplary embodiment, the black matrix layer 21 of the color filter substrate 2 is covered with the second surface common electrode 23 composed of an ITO or a metal. Therefore, an electric charge transfer to the black matrix layer 21 which is caused by an electric field generated by driving the LCD device 100 is intercepted with the second surface common electrode 23. That is, a vertical electric field is not generated between the TFT substrate 1 and the color filter substrate 2, because charge injection into the black matrix layer 21 by a peripheral electric field, or movement of an ion does not occur. Thereby, generation of screen burn-in, stains and spots by influence of the vertical electric field can be suppressed.

Since the comb-shaped common electrode comb-tooth 23B is provided in the color filter substrate 2, a transverse electric field near the color filter substrate 2 can be strengthened. Therefore, a driving voltage can be reduced and a higher transmittance can be obtained, because the transverse electric field strength is larger than that of the related LCD device at the same applied voltage.

### Modification 1 of the First Exemplary Embodiment

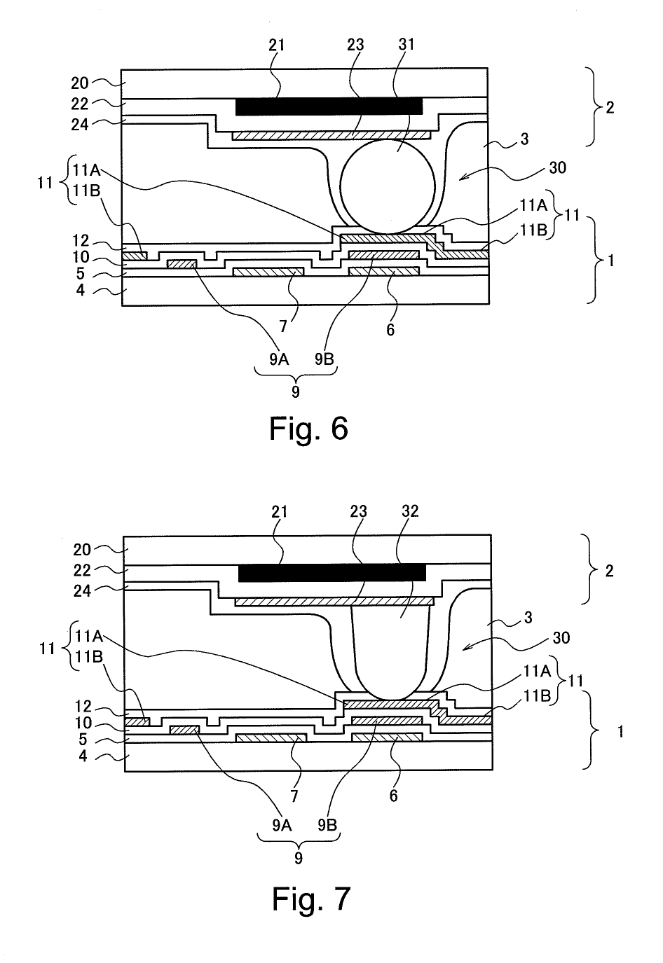

FIG. 6 is a cross sectional view (cross sectional view of a part corresponding to the line III-III in FIG. 1) showing a structure of the conducting part 30 in a modification 1 of the first exemplary embodiment.

In the first exemplary embodiment, the conductive spacer 31 is formed after forming the alignment film 24. On the other hand, in the modification 1, as shown in FIG. 6, the conductive spacer 31 is first arranged in a fixed position on the second surface common electrode 23, for example by means of an ink jet method or a printing method. The alignment film 24 is formed after that, and the TFT substrate 1 and the color filter substrate 2 are stuck together.

In the modification 1, when the TFT substrate 1 and the color filter substrate 2 are stuck by pressurization, the conductive spacer 31 breaks through the alignment films 12 and contacts with the first surface common electrode 11. Accordingly, conduction between the second surface common electrode 23 and the first surface common electrode 11 is fully obtained. Contrary to this, after arranging the conductive spacer 31 on the first surface common electrode 11, the alignment film 12 may be formed, and the TFT substrate 1 and the color filter substrate 2 may be stuck together.

### Modification 2 of the First Exemplary Embodiment

FIG. 7 is a cross sectional view (cross sectional view of a part corresponding to the line III-III in FIG. 1) showing a structure of the conducting part 30 in a modification 2 of the first exemplary embodiment.

The modification 2 differs from the modification 1 shown in FIG. 6 only in forming a conductive pillar 32 instead of the conductive spacer 31. After forming a conductive film on the second common electrode 23, the conductive pillar 32 can be formed by etching this conductive film so as to remain the conductive pillar 32, for example. As shown in FIG. 7, after forming the conductive pillar 32 on the second surface common electrode 23, the alignment film 24 is formed and the TFT substrate 1 and the color filter substrate 2 are stuck together. Without limiting to this, after forming the conductive pillar 32 on the first surface common electrode 11, the alignment film 12 may be formed, and the TFT substrate 1 and the color filter substrate 2 may be stuck together.

In the modification 2, by pressurization which is applied to at the time when the TFT substrate 1 and the color filter substrate 2 are stuck, the conductive pillar 32 breaks through the alignment film 12, and contacts with the first surface common electrode 11. Therefore, conduction between the second surface common electrode 23 and the first surface common electrode 11 is fully obtained. Of course in the first exemplary embodiment, the conductive pillar 32 can be used instead of the conductive spacer 31.

### Modification 3 of the First Exemplary Embodiment

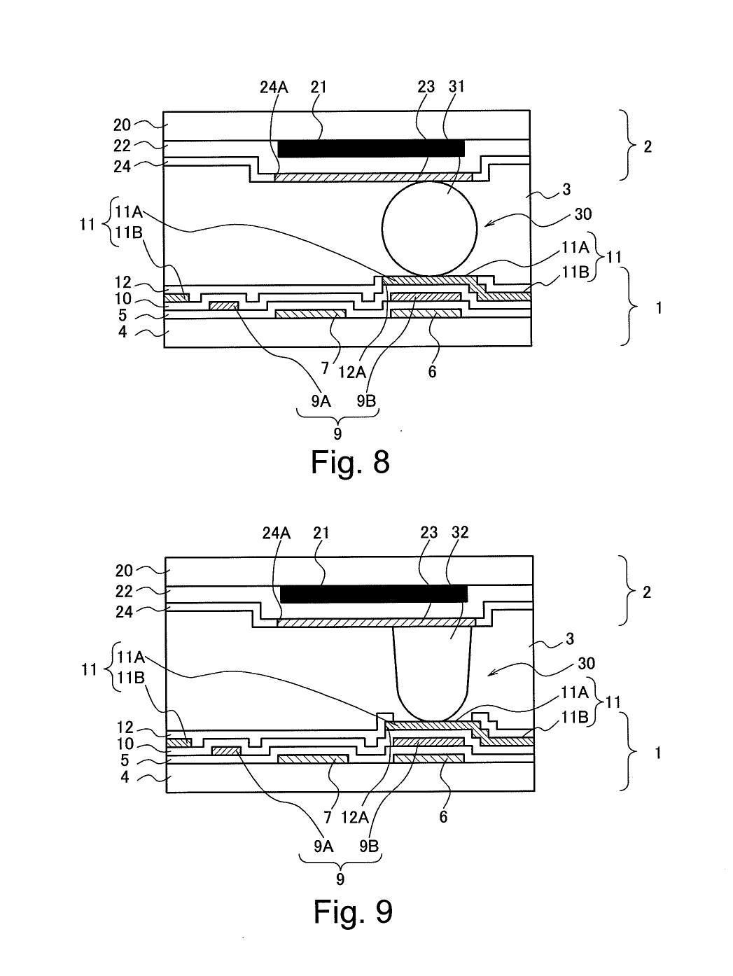

FIG. 8 and FIG. 9 are cross sectional views (cross sectional views of a part corresponding to the line III-III in FIG. 1) showing a structure of the conducting part 30 in a modification 3 of the first exemplary embodiment.

In the modification 3, openings 12A and 24A are formed in advance in a part of the alignment films 12 and 24, respectively where the conductive spacer 31 is arranged (refer to FIG. 8), or where the conductive pillar 32 is arranged (refer to FIG. 9). By this configuration, the conductive spacer 31 or the conductivity pillar 32 contacts with the first and the second surface common electrodes 11 and 23 directly without breaking through the alignment films 12 and 24. The modification 3 is particularly effective in the case that the alignment films 12 and 24 are composed of an inorganic alignment film etc., and they are rigid. It is because in this case it is difficult for the conductive spacer 31 or the conductive pillar 32 to break through the alignment films 12 and 24.

Although FIG. 9 shows an example in which the conductive pillar 32 is formed on the second surface common electrode 23, it may be formed on the first surface common electrode 11.

### A Second Exemplary Embodiment

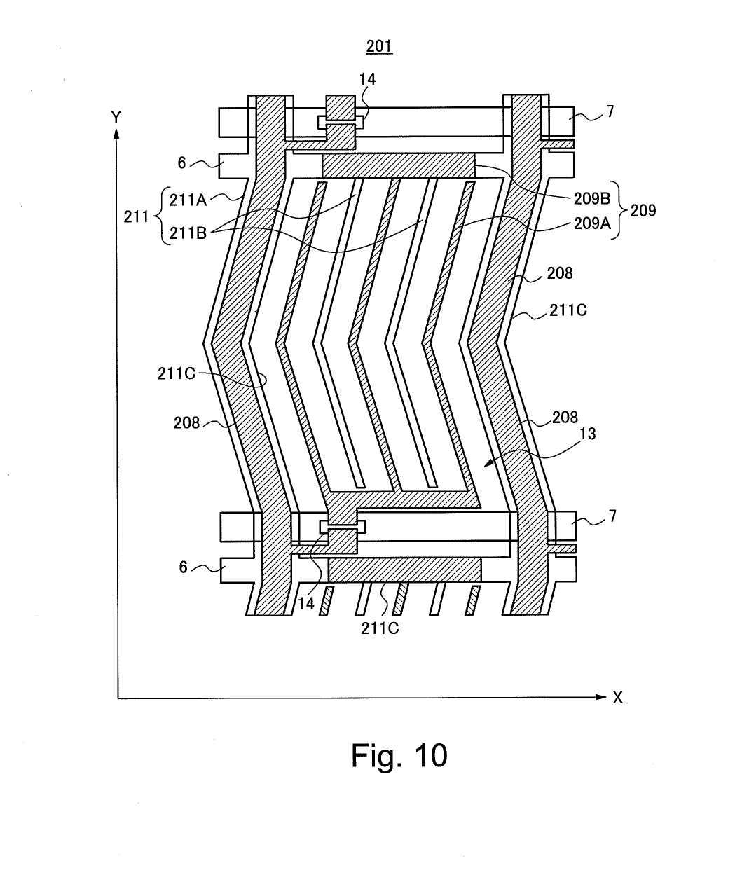

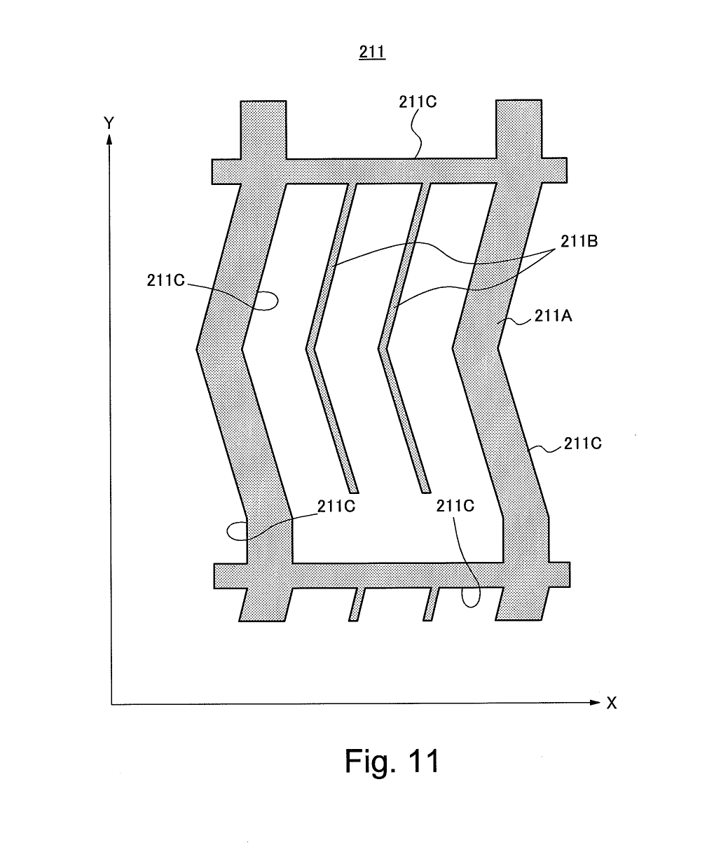

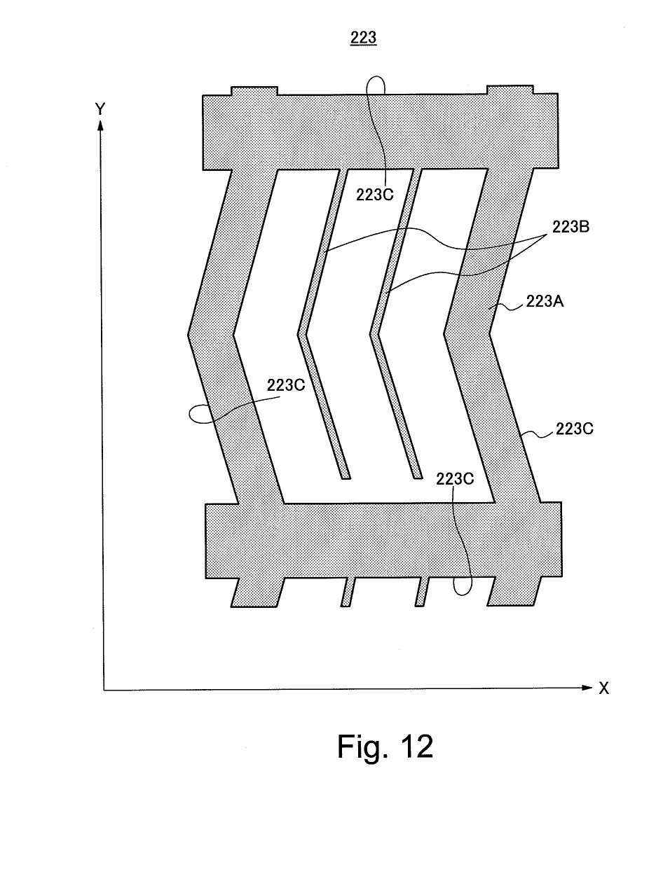

FIG. 10 is a plan view of a TFT substrate 201 provided in an LCD device according to a second exemplary embodiment, FIG. 11 is a plan view of a first surface common electrode 211 provided on the TFT substrate 201, and FIG. 12 is a plan view of a second surface common electrode 223 provided on a color filter substrate of the LCD device according to the second exemplary embodiment.

The LCD device according to the second exemplary embodiment is different from the LCD device 100 according to the first exemplary embodiment only in a point that a data line 208 (FIG. 10), a first surface common electrode 211 (FIG. 10, FIG. 11), a second surface common electrode 223 (FIG. 12), and a pixel electrode 209 (FIG. 10) are provided, respectively instead of the data line 8 (FIG. 1), the first surface common electrode 11 (FIG. 4), the second surface common electrode 23 (FIG. 5), and the pixel electrode 9 (FIG. 1) of the LCD device 100 according to the first exemplary embodiment. Other points therein are the same configuration as the LCD device 100 according to the first exemplary embodiment.

In the first exemplary embodiment, as shown in FIG. 1, the first surface common electrode 11, the second surface common electrode 23, the pixel electrode 9, and the data line 8 extend on the straight in the column direction (Y direction). In contrast, in this exemplary embodiment, as shown in FIG. 10, FIG. 11, and FIG. 12, portions extending in a column direction of a first surface common electrode 211, a second surface common electrode 223, a pixel electrode 209, and a data line 208 bend in at least one or more places, respectively, that is, they have zigzag shape structures. In the first common electrode 211, an opening 211C with a shape which has at least one or more bending parts in the column direction is formed in a position corresponding to each display area 13.

The first surface common electrode 211 includes a latticed part 211A and a common electrode comb-tooth 211B like the first exemplary embodiment. And the portion extending in the column direction of the latticed part 211A and the common electrode comb-tooth 211B bend in at least one or more places, respectively. FIG. 10 and FIG. 11 show a case where they bend at one place, respectively.

Similarly, an opening 223C with the same shape as an opening 211C is formed in the second surface common electrode 223 in a matrix form. The second surface common electrode 223 includes a latticed part 223A and a common electrode comb-tooth 223B like the first exemplary embodiment. And the portion extending in the column direction of the latticed part 223A and the common electrode comb-tooth 223B bend at least at one or more places, respectively. FIG. 12 shows a case where they bend each at one place.

The pixel electrode 209 includes a pixel electrode comb-tooth 209A and a storage capacitance formation part 209B like the first exemplary embodiment. And a portion extending in the column direction of the pixel electrode comb-tooth 209A bends at least at one or more places. FIG. 10 shows a case where it bends at one place.

Although illustration is omitted in this exemplary embodiment, a black matrix layer of the color filter substrate is bent like the data line 208.

While the same advantageous effect as the first exemplary embodiment is obtained according to the second exemplary embodiment, a new advantageous effect that an optical property in a slanting view improves is obtained, because the first and the second surface common electrodes 211 and 223 are bent, so a multi-domain in which a rotation direction of liquid crystal molecules differs from each other can be formed.

Although FIG. 10, FIG. 11, and FIG. 12 show the structures that the data line 208, the first surface common electrode 211, the second surface common electrode 223, and the pixel electrode 209 are bent only at one place in the column direction of the display pixel, respectively, it is not limited to these structures, and they may be bent at two or more places, respectively.

### A Third Exemplary Embodiment

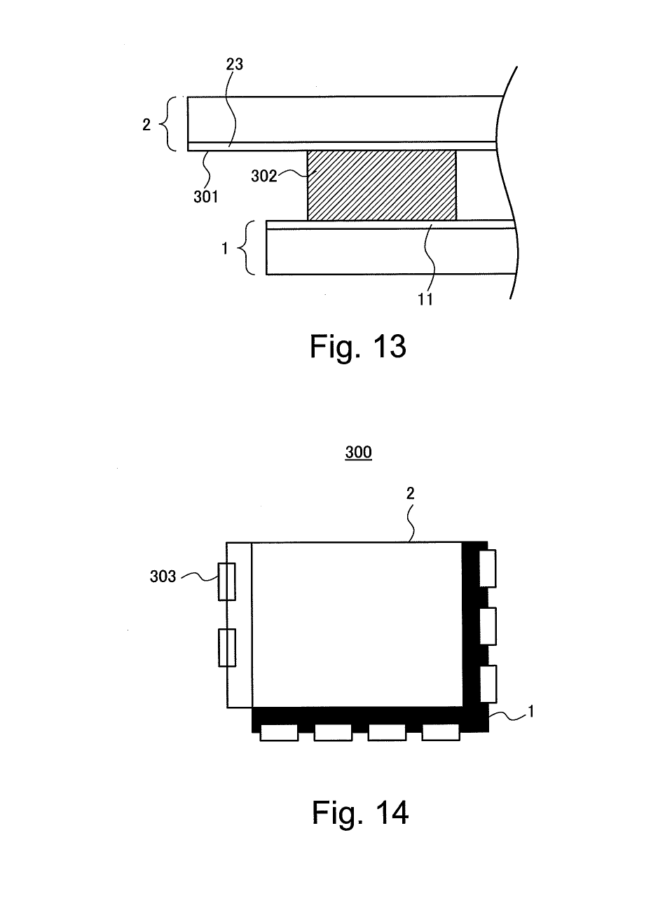

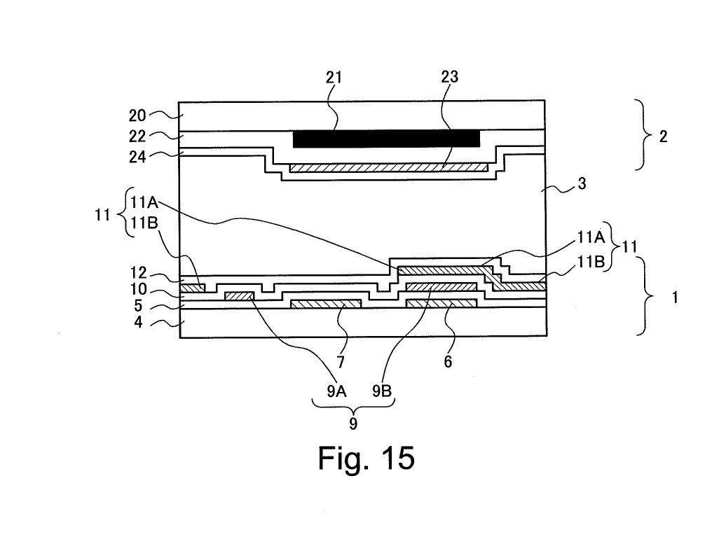

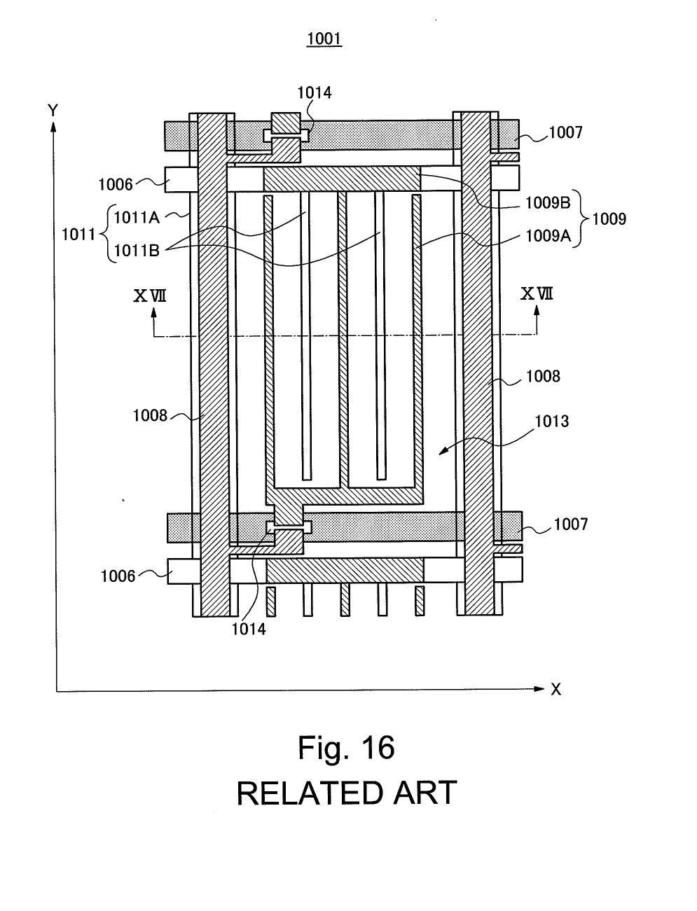

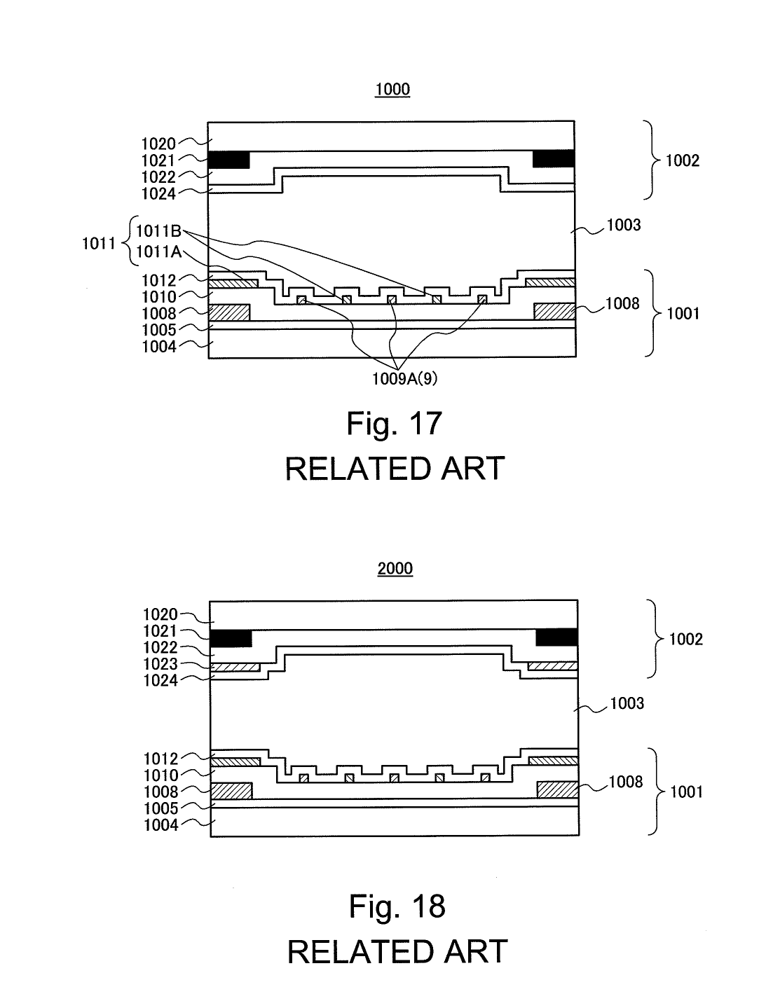

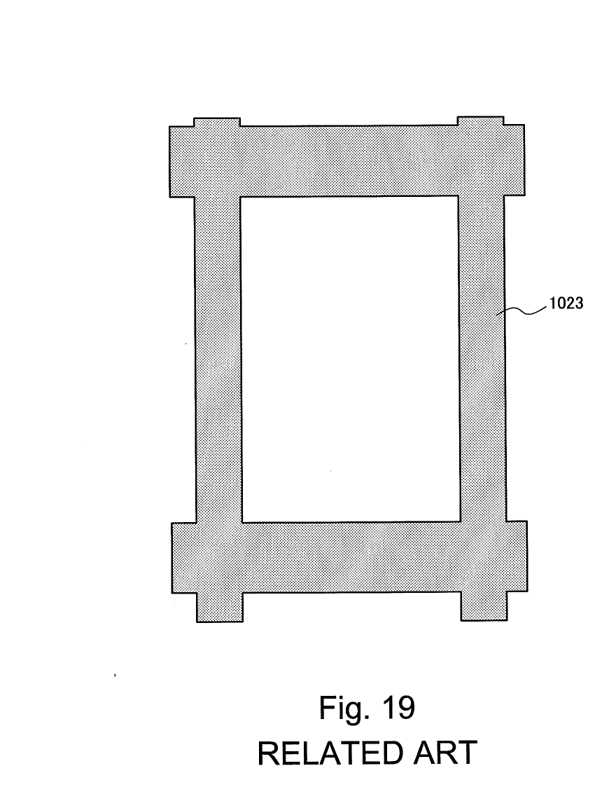

FIG. 13 is a cross-sectional view showing a structure of a peripheral edge part of a TFT substrate and a color filter substrate of an LCD device 300 (FIG. 14) according to a third exemplary embodiment, FIG. 14 is a plan view of the LCD device 300 according to the third exemplary embodiment, and FIG. 15 is a cross-sectional view of the LCD device 300 according to the third exemplary embodiment. FIG. 15 is a cross sectional view of a part corresponding to the line III-III in FIG. 1.

In this exemplary embodiment, as shown in FIG. 13, a terminal 301 is formed on a peripheral edge part of the color filter substrate 2. As shown in FIG. 14, a common electric potential input terminal 303 is connected to the terminal 301. Here, the same electric potential as a common electric potential inputted into a first surface common electrode 11 in the TFT substrate 1 is inputted into a second surface common electrode 23 via the terminal 301.

In this exemplary embodiment, the first surface common electrode 11 and the second surface common electrode 23 are not electrically connected mutually. Accordingly, as shown in FIG. 15, a component for electrically connecting the first surface common electrode 11 and the second surface common electrodes 23 mutually, such as the conductive spacer 31 or the conductive pillar 32 in the first or the second exemplary embodiment is not arranged.

As shown in FIG. 13, the color filter substrate 2 and the TFT substrate 1 are mutually joined by means of a sealing agent 302 in those peripheral edge portions.

According to the third exemplary embodiment, it is not required to input the common electric potential inputted into the TFT substrate 1 into the color filter substrate 2 through a conductive spacer or silver (Ag) paste. Therefore a loss in the common electric potential does not arise, because there is no contact resistance between the first or second surface common electrodes 11 or 23, and the conductive spacer or the silver (Ag) paste.

A fourth exemplary embodiment of the invention is that a conduction part for electrically connecting the first surface common electrode and the second surface common electrode mutually is formed, wherein a common electric potential inputted into one of the first surface common electrode and the second surface common electrodes is transmitted to other electrode thereof through the conduction part.

Furthermore, a fifth exemplary embodiment of the invention is that the conduction part is composed of a conductive spacer or a conductive pillar.

A sixth exemplary embodiment of the invention is that a terminal for inputting an electric potential into the second surface common electrode is formed on a peripheral edge part of the counter substrate, and a same common electric potential is inputted into the second surface common electrode through the terminal as well as into the first surface common electrode via the common electrode wiring.

A seventh exemplary embodiment of the invention is that the pixel electrode, the first surface common electrode, and the second surface common electrode are formed in parallel mutually, and they are formed in a zigzag shape, respectively.

An eighth exemplary embodiment of the invention is that the pixel electrode and the first surface common electrode are provided with a comb-tooth shaped portion projected into a display area of each display pixel, respectively so that an electric field along a principal plane of the TFT substrate can be applied to the liquid crystal thereby.

A ninth exemplary embodiment of the invention is that the second surface common electrode is provided with a comb-tooth shaped portion projected into a display area of each display pixel so that an electric field along a principal plane of the counter substrate can be applied to the liquid crystal thereby.

A tenth exemplary embodiment of the invention is that a driving method of a liquid crystal display device having a first surface common electrode and a second surface common electrode, including, inputting a same common electric potential into the second surface common electrode as well as into the first surface common electrode, wherein the liquid crystal display device including, a thin film transistor (TFT) substrate having a substrate and a display pixel arranged in a matrix form on the substrate, with the display pixel including a plurality of scanning lines, a plurality of signal lines, a plurality of common electrode wirings, a plurality of pixel electrodes, a plurality of thin film transistors and a first surface common electrode electrically connected with the common electrode wiring, a counter substrate opposed to the TFT substrate and being stuck therewith, and a liquid crystal enclosed between the TFT substrate and the counter substrate, wherein the pixel electrode and the first surface common electrode are arranged so that an electric field along a principal plane of the TFT substrate can be applied to the liquid crystal, a second surface common electrode is formed on the counter substrate, the second surface common electrode is opposed to the first surface common electrode, the counter substrate further has a light-shielding layer with a light-shielding function, the second surface common electrode is formed covering the light shielding layer, and the second surface common electrode is arranged so that an electric field along a principal plane of the counter substrate can be applied to the liquid crystal.

The related IPS mode LCD device described in the background art causes a problem that a high driving voltage is required. This is due to the following reasons. Because the common electrode comb-tooth 1011B is formed only in the TFT substrate 1001 in the related LCD device 1000 which drives a liquid crystal by means of a transverse electric field, the transverse electric field intensity becomes weaker near the opposing color filter substrate 1002. Therefore, near the color filter substrate 1002, it is more difficult to rotate a liquid crystal molecule than near the TFT substrate 1001. Accordingly, higher voltage is required in order to fully rotate the liquid crystal molecule also near the color filter substrate 1002.

Also in the related arts disclosed by Japanese Patent Application Laid-Open No. 2000-147482 and No. 2006-031022 which are described in the background art, since the common electrode comb-tooth is formed only in the TFT substrate, an electric field along a principal plane of the substrate is applied to the liquid crystal only from the TFT substrate. Therefore, a driving voltage cannot be reduced.

An exemplary advantage according to the present invention is that the failures, such as a spot, a stain, a burn-in, and an afterimage, etc. can be suppressed and lowering of a driving voltage can be realized.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. A liquid crystal display device, comprising:
a thin film transistor (TFT) substrate including a substrate and a display pixel arranged in a matrix form on said substrate, with said display pixel including a plurality of scanning lines, a plurality of signal lines, a plurality of common electrode wirings, a plurality of pixel electrodes, a plurality of thin film transistors and a first surface common electrode connected with said common electrode wiring;
a counter substrate opposed to said TFT substrate and being stuck therewith; and
a liquid crystal enclosed between said TFT substrate and said counter substrate,
wherein said pixel electrode and said first surface common electrode are arranged so that an electric field along a principal plane of said TFT substrate can be applied to said liquid crystal, a second surface common electrode is formed on said counter substrate, a same common electric potential is inputted into said second surface common electrode as well as into said first surface common electrode, said second surface common electrode is opposed to said first surface common electrode, said counter substrate further has a light-shielding layer with a light-shielding function, said second surface common electrode is formed covering said light-shielding layer, and said second surface common electrode is arranged so that an electric field along a principal plane of said counter substrate can be applied to said liquid crystal.

2. The liquid crystal display device according to claim 1, further including a conduction part for electrically connecting said first surface common electrode and said second surface common electrode mutually,
wherein a common electric potential inputted into one of said first surface common electrode and said second surface common electrodes is transmitted to other electrode thereof through said conduction part.

3. The liquid crystal display device according to claim 2, wherein said conduction part is composed of a conductive spacer or a conductive pillar.

4. The liquid crystal display device according to claim 1, wherein a terminal for inputting an electric potential into said second surface common electrode is formed on a peripheral edge part of said counter substrate, and a same common electric potential is inputted into said second surface common electrode through said terminal as well as into said first surface common electrode via said common electrode wiring.

5. The liquid crystal display device according to claim 1, wherein said pixel electrode, said first surface common electrode, and said second surface common electrode are formed in parallel mutually, and they are formed in a zigzag shape, respectively.

6. The liquid crystal display device according to claim 1, wherein said pixel electrode and said first surface common electrode are provided with a comb-tooth shaped portion projected into a display area of each display pixel, respectively so that an electric field along a principal plane of said TFT substrate can be applied to said liquid crystal thereby.

7. The liquid crystal display device according to claim 6, wherein said second surface common electrode is provided with a comb-tooth shaped portion projected into a display area of each display pixel so that an electric field along a principal plane of said counter substrate can be applied to said liquid crystal thereby.

8. A driving method of a liquid crystal display device having a first surface common electrode and a second surface common electrode, comprising:
inputting a same common electric potential into said second surface common electrode as well as into said first surface common electrode,
wherein said liquid crystal display device comprising,
a thin film transistor (TFT) substrate including a substrate and a display pixel arranged in a matrix form on said substrate, with said display pixel including a plurality of scanning lines, a plurality of signal lines, a plurality of common electrode wirings, a plurality of pixel electrodes, a plurality of thin film transistors and a first surface common electrode electrically connected with said common electrode wiring;
a counter substrate opposed to said TFT substrate and being stuck therewith; and
a liquid crystal enclosed between said TFT substrate and said counter substrate,
wherein said pixel electrode and said first surface common electrode are arranged so that an electric field along a principal plane of said TFT substrate can be applied to said liquid crystal, a second surface common electrode is formed on said counter substrate, said second surface common electrode is opposed to said first surface common electrode, said counter substrate further has a light-shielding layer with a light-shielding function, said second surface common electrode is formed covering said light shielding layer, and said second surface common electrode is arranged so that an electric field along a principal plane of said counter substrate can be applied to said liquid crystal.
